(19) United States
(12) Patent Application Publication
(10) Pub. No.: US 2007/0175977 A1
(43) Pub. Date: Aug. 2, 2007

(54) System, method, and computer program product for processing payments with a virtual preauthorized draft

(75) Inventors: Thomas M. Bauer, Clarendon Hills, IL (US); Vernon Marshall, Montclair, NJ (US); Greg D. Sterner, Taylorsville, UT (US)

Correspondence Address: STERNE, KESSLER, GOLDSTEIN & FOX, P.L.L.C., 1100 NEW YORK AVENUE, N.W., WASHINGTON, DC, 20005-3934, US

(73) Assignee: American Express Travel Related Services Company, Inc., New York, NY (US)

(21) Appl. No.: 11/409,095

(22) Filed: Apr. 24, 2006

Related U.S. Application Data
(60) Provisional application No. 60/704,897, filed on Aug. 3, 2005.

(51) Int. Cl. G07F 19/00; G06Q 40/00

(52) U.S. Cl. 235/379; 705/39

(57) ABSTRACT

An image-based check processing software has the ability to create an electronic check form to be displayed, printed and/or exported to a file. Using various text fonts, such as the Magnetic Ink Character Recognition (MICR) font, a new electronic form has been created from text data that has all the characteristics of a preauthorized draft. As computer and phone payments are processed by a financial institution, the virtual draft will be created if the routing/transit numbers of the paying institution accept images of checks as presentment through, for example, an image exchange program or the eventual printing of a substitute check. The transactions will then be routed to the financial institution who will import the necessary data to create the virtual check. The image will then be presented for payment.

### BACKGROUND OF THE INVENTION

1. Field of the Invention

The present invention relates to processing paperless drafts from an account holder.

2. Background Art

In an accounts receivable conversion (“ARC”) transaction, a type of check-clearing transaction, a Magnetic Ink Character Recognition (“MICR”) line of a check is read with a mechanical or optical system, which recognizes codes contained therein. The amount of the check is then encoded. Transactions are then aggregated and submitted in an automated clearing house (“ACH”) batch file. The batch files include, for each check, header data, a file with the MICR line data, and proof of amount data. The original paper checks are then stored for a period of time and the resulting ARC transaction is cleared through the ACH network. Check processing using ARC is limited to certain types of transactions under the current regulatory environment.

The Check Clearing for the 21^{st} Century Act (Pub. L. No. 108-100, 117 Stat. 1177) (incorporated by reference herein in its entirety), went into effect on Oct. 28, 2004. The Act provides for Check 21, which is an alternative to the ARC procedure. Although Check 21 legislation does not mandate any image clearing, it allows for the creation of a substitute check, which is the legal equivalent of an original check signed by a payor. This gives a bank more flexibility in allowing a check to clear as an image. An account holder's bank has the option of accepting the image of the check in place of the original check if the bank of first deposit has certified the image file. Check 21 provides for the creation of substitute checks when the account holder's bank does not accept images. Substitute checks are printed versions of a scanned original check, including the MICR line data, and are considered to have the same authority as an original check.

Currently, the Check 21 procedure is being used to scan and process original checks written by a payor. However, payments by consumers over the Internet or via a telephone are becoming increasingly popular. Therefore, what is needed is a system and method that leverage images and substitute checks for processing these and other types of preauthorized drafts that are compatible with both ACH and Check 21 procedures.

### BRIEF SUMMARY OF THE INVENTION

An image-based check processing system, method, and computer program product has the ability to create an electronic form to be displayed, printed, and/or exported to a file. Using various text fonts, a new electronic form has been created from text data that has all the characteristics of a preauthorized draft. As computer and phone payments are processed, these virtual preauthorized drafts will be created if the routing/transit servers of the paying institution accepts images of checks as presentment, or if the paying institution accepts substitute checks. The transactions will then be routed to a financial service provider platform. The financial service provider platform will import the necessary data to create the virtual draft, and the image will be presented for payment.

Further embodiments, features, and advantages of the present invention, as well as the structure and operation of the various embodiments of the present invention, are described in detail below with reference to the accompanying drawings.

### BRIEF DESCRIPTION OF THE DRAWINGS/FIGURES

The accompanying drawings, which are incorporated herein and form a part of the specification, illustrate the present invention and, together with the description, further serve to explain the principles of the invention and to enable a person skilled in the pertinent art to make and use the invention.

FIG. 1 is a diagram of a draft processing system.

FIG. 2 is a flowchart of a draft processing method.

FIG. 3 is a block diagram of an exemplary computer system useful for implementing the present invention.

FIG. 4A illustrates the front of an exemplary substitute check.

FIG. 4B illustrates the back of the exemplary substitute check of FIG. 4A.

FIG. 5 illustrates an electronic form for a virtual preauthorized draft.

The present invention will be described with reference to the accompanying drawings. The drawing in which an element first appears is typically indicated by the leftmost digit(s) in the corresponding reference number.

### DETAILED DESCRIPTION OF THE INVENTION

I. Overview

While specific configurations and arrangements are discussed, it should be understood that this is done for illustrative purposes only. A person skilled in the pertinent art will recognize that other configurations and arrangements can be used without departing from the spirit and scope of the present invention. It will be apparent to a person skilled in the pertinent art that this invention can also be employed in a variety of other applications.

The terms “user,” “end user”, “consumer”, “customer,” “participant,” and/or the plural form of these terms are used interchangeably throughout herein to refer to those persons or entities capable of accessing, using, being affected by and/or benefiting from the tool that the present invention provides.

Furthermore, the terms “business” or “merchant” may be used interchangeably with each other and shall mean any person, entity, distributor system, software and/or hardware that is a provider, broker and/or any other entity in the distribution chain of goods or services. For example, a merchant may be a grocery store, a retail store, a travel agency, a service provider, an on-line merchant or the like.

1. Transaction Accounts and Instrument

A “transaction account” as used herein refers to an account associated with an open account or a closed account system, such as a checking account.

Furthermore, a physical embodiment of a transaction account may be distributed as a financial instrument, such as a check or draft.

2. Use of Transaction Accounts

With regard to use of a transaction account, users may communicate with merchants in person (e.g., at the box office), telephonically, or electronically (e.g., from a user computer via the Internet). During the interaction, the merchant may offer goods and/or services to the user. The merchant may also offer the user the option of paying for the goods and/or services using any number of available transaction accounts. Furthermore, the transaction accounts may be used by the merchant as a form of identification of the user. The merchant may have a computing unit implemented in the form of a computer-server, although other implementations are possible.

In general, transaction accounts may be used for transactions between the user and merchant through any suitable communication means, such as, for example, a telephone network, intranet, the global, public Internet, a point of interaction device (e.g., a point of sale (POS) device, personal digital assistant (PDA), mobile telephone, kiosk, etc.), online communications, off-line communications, wireless communications, and/or the like.

3. Account and Merchant Numbers

An “account,” “account number” or “account code”, as used herein, may include any device, code, number, letter, symbol, digital certificate, smart chip, digital signal, analog signal, biometric or other identifier/indicia suitably configured to allow a consumer to access, interact with or communicate with a financial transaction system. The account number may optionally be located on or associated with any financial transaction instrument.

Each bank has its own account numbering system, and each bank's issued account numbers comply with that company's standardized format. A merchant account number may be, for example, any number or alpha-numeric characters that identify a particular merchant for purposes of check routing, account reconciliation, reporting and the like.

II. Process and System

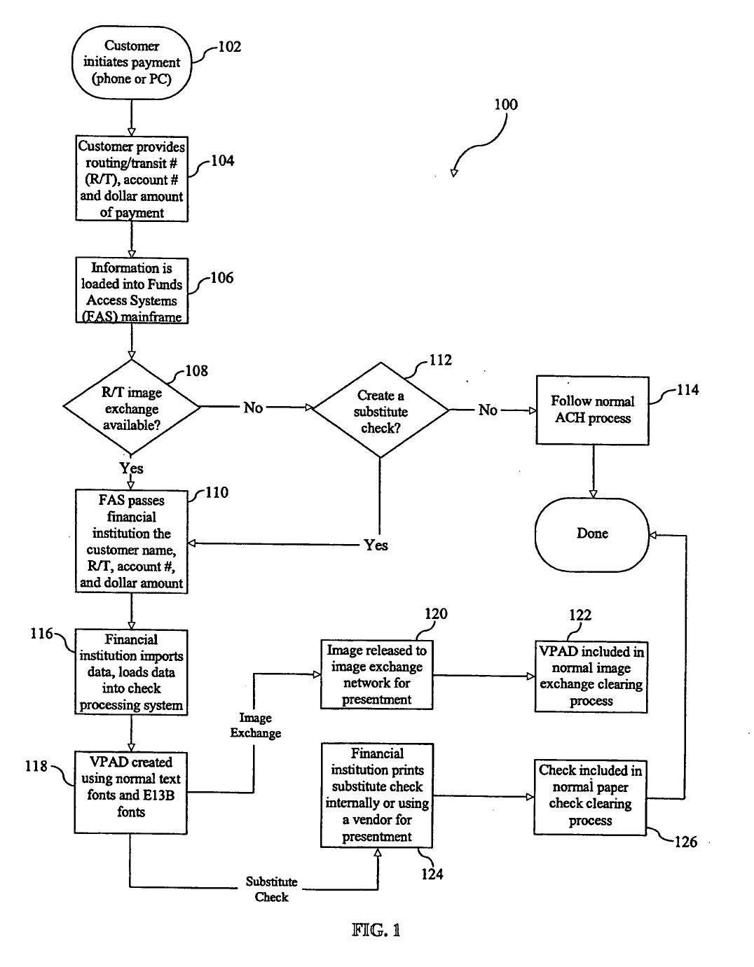

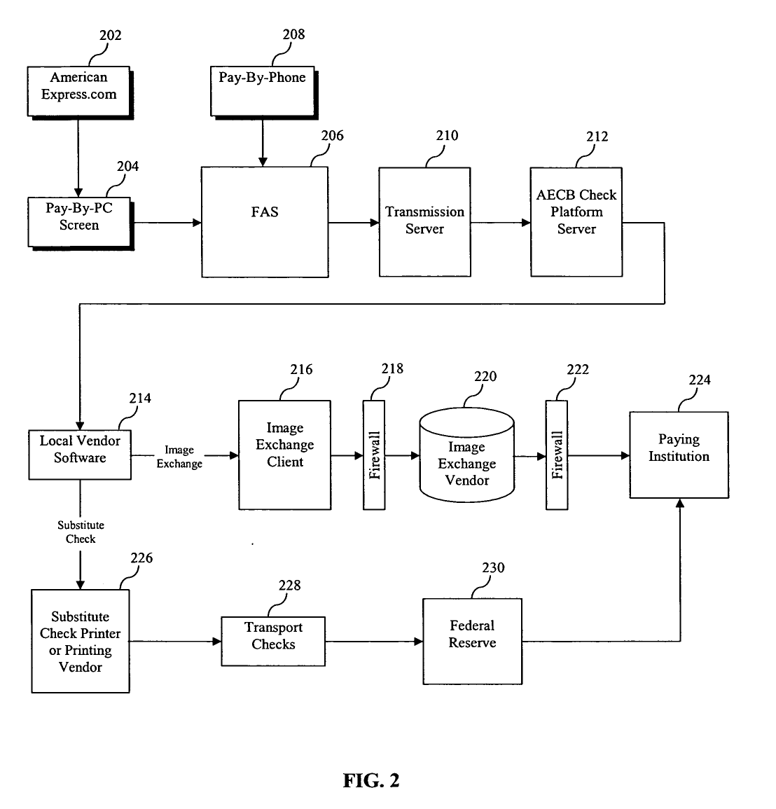

FIG. 1 is a flowchart of a draft processing method 100 according to an embodiment of the present invention. Method 100 will also be described with reference to FIG. 2. FIG. 2 is a diagram of an exemplary draft processing system.

In step 102, a customer wanting a draft to be processed electronically initiates payment through a financial institution, such as American Express Centurion Bank of Salt Lake City, Utah. Payment can be initiated in multiple forms, such as via telephone or over the Internet. If payment is to be initiated over the Internet, the customer may access a financial institution's website, such as website 202. Although the present invention will be described herein as originating with an authorization from the consumer over the telephone or electronically, one of skill in the relevant art(s) will also recognize that the virtual preauthorized draft system and method may also apply to payments originating from traditional preauthorized drafts, such as non-ACH-capable drafts, for any type of debit or credit transaction.

In step 104, the customer provides information to be included on the virtual draft. This information may include, for example and without limitation, a routing and/or transit number, an account number, and a dollar amount of payment. This information may be taken by an automated system or by an operator. If the payment is initiated over the Internet, the customer information may be entered in the appropriate area on the financial institution's website, such as a pay-by-PC screen 204. If the payment is initiated via telephone, the customer connects through a telephone system 208 to an operator or automated system.

Alternatively, customer payment information may come from transactions that have previously been originated as preauthorized drafts. In this case, data is transferred from the existing preauthorized draft and entered into the virtual preauthorized draft.

In step 106, the information provided by the customer is transferred to the financial institution. For example, the customer information may be loaded into a funds access system (“FAS”) mainframe 206.

In step 108, it is determined whether the requested transaction is eligible for routing/transit image exchange. If the transaction is eligible for image exchange, method 100 proceeds to step 110.

If the transaction is not eligible for image exchange, it is determined in step 112 whether a substitute check may be created. A substitute check is a paper reproduction of the original check, which includes an image of the front and back of the original check. A substitute check has the same legal status as an original check under Check 21.

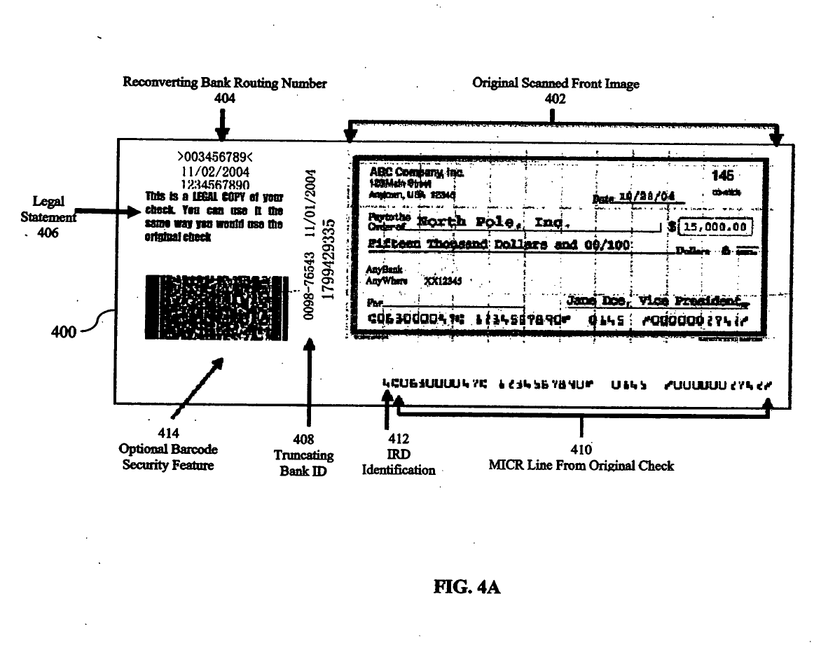

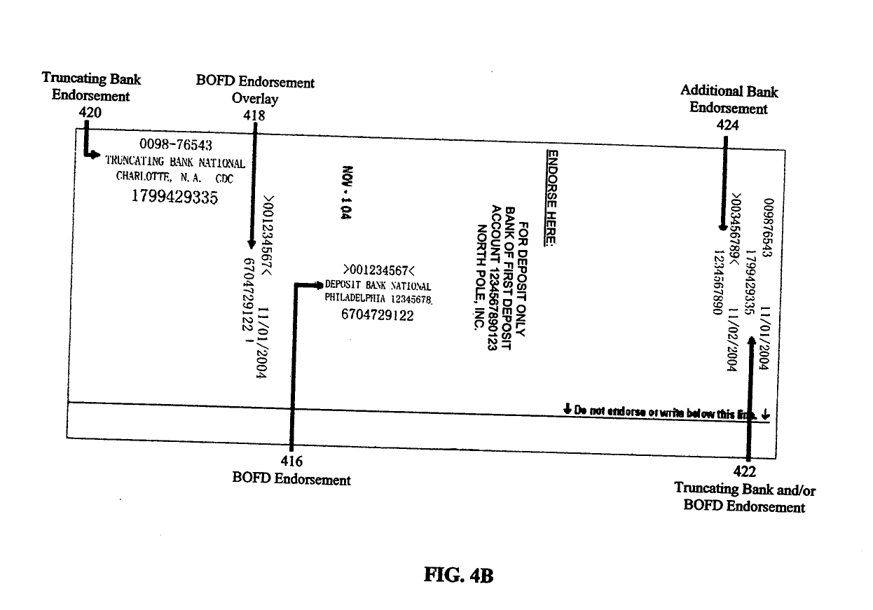

The front of an exemplary substitute check 400 is illustrated in FIG. 4A. The size of the substitute check is governed by standards outlined by the American Banking Association (“ABA”) and American National Standards Institute (“ANSI”). A reduced image 402 of the original scanned front of the check appears on the side of the substitute check front. A routing number 404 shows the routing number for the bank that created the substitute check, which is also referred to as the reconverting bank. A legal statement 406 informs the recipient that the substitute check is a copy of the original check, and can be used in the same way that the original check would be used. The truncating bank is identified in truncating bank identification 408. As will be described below, a truncating bank is the bank that removes the original check from the check clearing process.

The substitute check also includes MICR line data 410 found on the original check. An image replacement document (“IRD”) identification number 412 is included with the MICR line data 410 to identify the check as a substitute check. An optional bar code security feature 414 may also be included on the front of substitute check 400.

FIG. 4B illustrates the back of exemplary substitute check 400. A reduced image of the original scanned back of the check appears on the side of the substitute check back. An endorsement 416 and endorsement overlay 418 from the bank of first deposit (“BOFD”) is shown on the scanned back of the original check, as is an endorsement 420 from the truncating bank, if the truncating bank is different from the BOFD. The truncating bank (which may be the BOFD) also endorses the substitute check image, as shown by truncating bank endorsement 422. Endorsements from subsequent banks are also included on the back of the substitute check, as is shown by additional bank endorsement 424.

If a substitute check is allowed in step 112, method 100 proceeds to step 110. If a substitute check is not allowed for the particular transaction, method 100 proceeds to step 114, where the normal ACH process is followed to clear the draft.

In step 110, the customer name, routing/transit number, account number, and dollar amount is passed to the financial institution. This may be accomplished by, for example, a transmission server 210 connected directly or indirectly to FAS mainframe 206.

In step 116, the customer information provided by FAS mainframe 206 and/or transmission server 210 is imported and processed by a check processing system, such as check platform server 212.

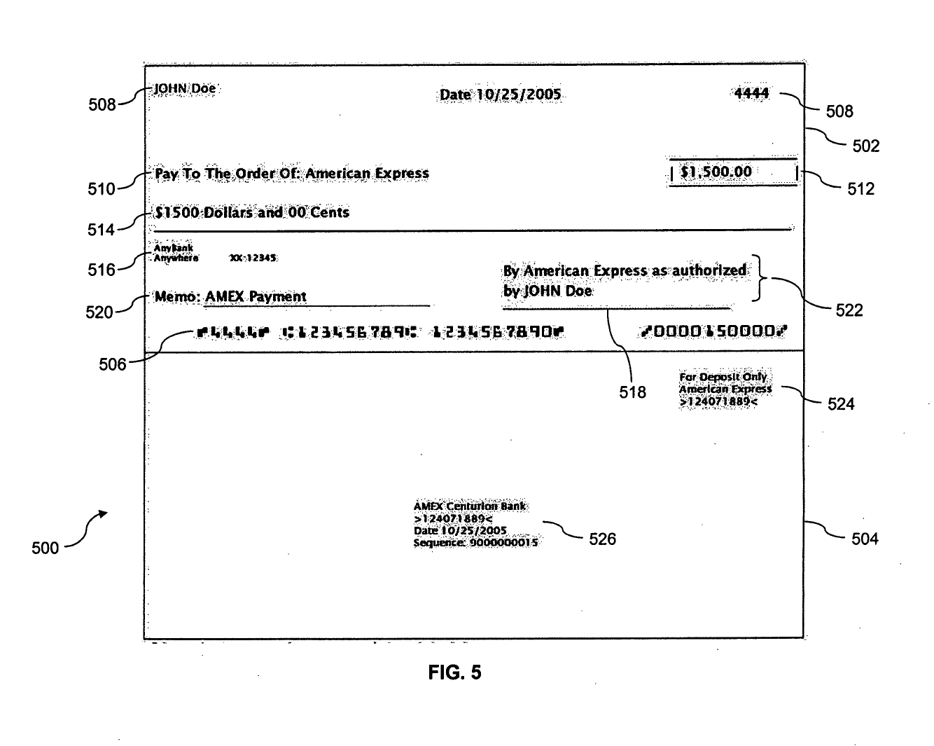

In step 118, a virtual preauthorized draft is created by inserting the customer information into an electronic form having the design of a draft. An illustration of an example electronic (virtual) preauthorized draft form 500 is illustrated in FIG. 5.

Form 500 includes a front 502 and a back 504. Form 500 may use a combination of normal text fonts and E13B, or MICR, fonts. As will be appreciated by one skilled in the relevant art(s), the MICR E13B font is a special font that is used on bank checks and drafts in the United States, Canada, Puerto Rico, Panama, the United Kingdom, and a few other countries to print MICR characters for magnetic recognition and optical character recognition systems.

The MICR E13B fonts were created according to the International Organization for Standardization. The font allows for the printing of MICR numbers and codes from computer systems (e.g., Microsoft Windows, DOS, Macintosh, and UNIX) supporting TrueType, PostScript or PCL LaserJet soft fonts to graphics printers.

When completed, the format of the virtual draft resembles that of a paper check in standard check format, and the virtual draft includes all information necessary to be processed as a paper check once it has been printed out. For example, the MICR line at the bottom of a check, which includes a routing number, transit number, and account number for the paying institution, can be displayed on the virtual preauthorized draft in the appropriate MICR font as MICR line 506. When printed, this information may be printed in magnetic ink so as to be processed by MICR readers.

Form 500 may also include a payor identification section 508, a check number indication section 509, a payee identification section 510, a numerical payment amount identification section 512, a textual payment amount identification section 514, a payor bank identification section 516, a signature area 518, and a memorandum area 520. The virtual preauthorized draft may also include a disclosure 522 in the signature area of the draft indicating that the customer has authorized the preauthorized draft.

Back 504 of virtual preauthorized draft 500 may include payee endorsement 524 and BOFD endorsement 526, as they would appear on physical check. The virtual draft may be designed using software such as, for example and without limitation, the Image Vision program produced by Advanced Financial Solutions of Oklahoma City, Okla.

Returning to FIG. 1, after step 118 it is determined whether the transaction is available for image exchange. If it is determined that the transaction is eligible for image exchange, method 100 proceeds to step 120. In step 120, the image of the draft is released to an image exchange network such as image exchange client 216 for presentment to the account holder's bank, or paying institution 224. Release to the image exchange network may be provided through what will be referred to herein as the Check 21 procedure.

Under the Check 21 procedure, a payor writes an original check to a payee, such as a merchant. The payee then deposits the check with a BOFD. The BOFD may decide to truncate the original check. “Truncate” as used herein refers to removing an original check from the clearing process and replacing it with information contained thereon. To truncate the original check under the Check 21 procedure, the BOFD captures an image of the front and back of the original check, as well as the MICR line data on the original check. The image and the MICR line data are then sent electronically to a second bank.

The second bank may be the paying institution. In this case, the electronic image and data are processed by the paying institution, and the payor's account is debited.

Alternatively, the second bank may not be the paying institution, but an image exchange vendor or middleman. The image exchange vendor thus needs to transfer the check to the paying institution. If the paying institution accepts checks electronically, the image exchange vendor transfers the check image and MICR line data to the paying institution for processing. However, if the paying institution does not accept check images, the image exchange vendor uses the check image and MICR line data to create a substitute check. Once the substitute check is created, the image exchange vendor physically transfers the substitute check to the paying institution. The paying institution then processes the substitute check in the same manner as an original paper check.

Returning to FIG. 1, in step 122 the virtual preauthorized draft is included in the normal image exchange clearing process. This image exchange clearing process may include, for example and without limitation, passing through a firewall 218 between image exchange client 216 and an image exchange vendor 220. Image exchange vendor 220 routes the image to paying institution 224 through a firewall 222 for payment by paying institution 224.

If, after step 118, it is determined that the transaction is not eligible for image exchange or the ACH process, it is determined whether the transaction is eligible for clearance using a substitute check. If the transaction is eligible for clearance using substitute checks, method 100 proceeds to step 124. In step 124, the financial institution prints a substitute check internally or using a vendor for presentment to the account holder's bank. This is accomplished using, for example, substitute check printer or printing vendor 226. In step 126, the substitute check is included in the normal paper check clearing process. The paper check clearing process may include physically transporting the substitute check via transportation unit 228 to an intermediary clearing agent or a Federal Reserve Bank (“FSB”), such as FSB 230. FSB 230 then routes the substitute check to paying institution 224 for payment.

III. Example Implementations

The present invention (i.e., method 100 or system 200 or any part(s) or function(s) thereof) may be implemented using hardware, software or a combination thereof and may be implemented in one or more computer systems or other processing systems. However, the manipulations performed by the present invention were often referred to in terms, such as editing or comparing, which are commonly associated with mental operations performed by a human operator. No such capability of a human operator is necessary, or desirable in most cases, in any of the operations described herein which form part of the present invention. Rather, the operations are machine operations. Useful machines for performing the operation of the present invention include general purpose digital computers or similar devices.

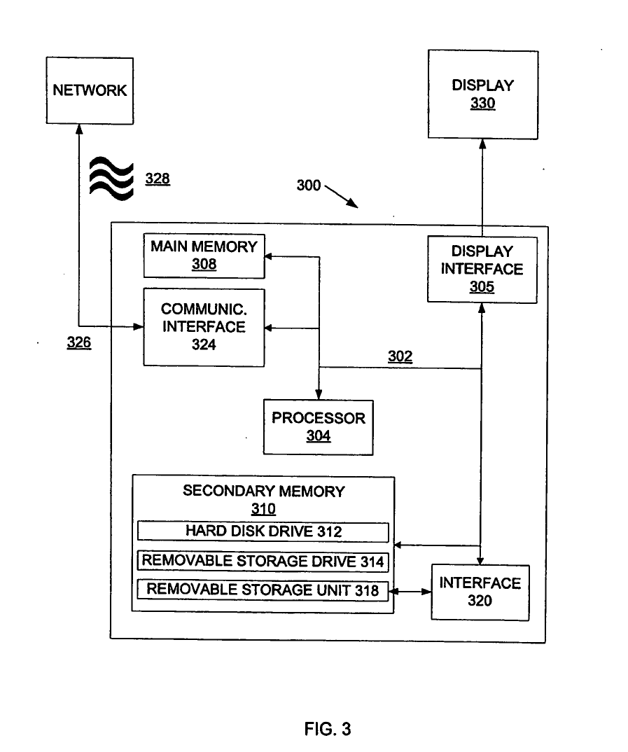

In fact, in one embodiment, the invention is directed toward one or more computer systems capable of carrying out the functionality described herein. An example of a computer system 300 is shown in FIG. 3.

The computer system 300 includes one or more processors, such as processor 304. The processor 304 is connected to a communication infrastructure 306 (e.g., a communications bus, cross-over bar, or network). Various software embodiments are described in terms of this exemplary computer system. After reading this description, it will become apparent to a person skilled in the relevant art(s) how to implement the invention using other computer systems and/or architectures.

Computer system 300 can include a display interface 302 that forwards graphics, text, and other data from the communication infrastructure 306 (or from a frame buffer not shown) for display on the display unit 330.

Computer system 300 also includes a main memory 308, preferably random access memory (RAM), and may also include a secondary memory 310.

The secondary memory 310 may include, for example, a hard disk drive 312 and/or a removable storage drive 314, representing a floppy disk drive, a magnetic tape drive, an optical disk drive, etc. The removable storage drive 314 reads from and/or writes to a removable storage unit 318 in a well known manner.

Removable storage unit 318 represents a floppy disk, magnetic tape, optical disk, etc. which is read by and written to by removable storage drive 314. As will be appreciated, the removable storage unit 318 includes a computer usable storage medium having stored therein computer software and/or data.

In alternative embodiments, secondary memory 310 may include other similar devices for allowing computer programs or other instructions to be loaded into computer system 300. Such devices may include, for example, a removable storage unit 318 and an interface 320. Examples of such may include a program cartridge and cartridge interface (such as that found in video game devices), a removable memory chip (such as an erasable programmable read only memory (EPROM), or programmable read only memory (PROM)) and associated socket, and other removable storage units 318 and interfaces 320, which allow software and data to be transferred from the removable storage unit 318 to computer system 300.

Computer system 300 may also include a communications interface 324.

Communications interface 324 allows software and data to be transferred between computer system 300 and external devices. Examples of communications interface 324 may include a modem, a network interface (such as an Ethernet card), a communications port, a Personal Computer Memory Card International Association (PCMCIA) slot and card, etc. Software and data transferred via communications interface 324 are in the form of signals 328 which may be electronic, electromagnetic, optical or other signals capable of being received by communications interface 324. These signals 328 are provided to communications interface 324 via a communications path (e.g., channel) 326. This channel 326 carries signals 328 and may be implemented using wire or cable, fiber optics, a telephone line, a cellular link, an radio frequency (RF) link and other communications channels.

In this document, the terms “computer program medium” and “computer usable medium” are used to generally refer to media such as removable storage drive 314, a hard disk installed in hard disk drive 312, and signals 328. These computer program products provide software to computer system 300. The invention is directed to such computer program products.

Computer programs (also referred to as computer control logic) are stored in main memory 308 and/or secondary memory 310. Computer programs may also be received via communications interface 324. Such computer programs, when executed, enable the computer system 300 to perform the features of the present invention, as discussed herein. In particular, the computer programs, when executed, enable the processor 304 to perform the features of the present invention. Accordingly, such computer programs represent controllers of the computer system 300.

In an embodiment where the invention is implemented using software, the software may be stored in a computer program product and loaded into computer system 300 using removable storage drive 314, hard drive 312 or communications interface 324. The control logic (software), when executed by the processor 304, causes the processor 304 to perform the functions of the invention as described herein.

In another embodiment, the invention is implemented primarily in hardware using, for example, hardware components such as application specific integrated circuits (ASICs). Implementation of the hardware state machine so as to perform the functions described herein will be apparent to persons skilled in the relevant art(s).

In yet another embodiment, the invention is implemented using a combination of both hardware and software.

IV. Conclusion

While various embodiments of the present invention have been described above, it should be understood that they have been presented by way of example, and not limitation. It will be apparent to persons skilled in the relevant art(s) that various changes in form and detail can be made therein without departing from the spirit and scope of the present invention. Thus, the present invention should not be limited by any of the above described exemplary embodiments, but should be defined only in accordance with the following claims and their equivalents.

In addition, it should be understood that the figures and screen shots illustrated in the attachments, which highlight the functionality and advantages of the present invention, are presented for example purposes only. The architecture of the present invention is sufficiently flexible and configurable, such that it may be utilized (and navigated) in ways other than that shown in the accompanying figures.

Further, the purpose of the foregoing Abstract is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. The Abstract is not intended to be limiting as to the scope of the present invention in any way.

What is claimed is:

1. A method of processing a preauthorized draft, comprising:
receiving customer information including a routing number, transit number, account number, and amount of payment;
creating a virtual preauthorized draft based on the customer information, wherein the format of the virtual preauthorized draft resembles standard check format; and
presenting the virtual preauthorized draft to an exchange network for payment on the draft.

2. The method of claim 1, wherein the presenting step comprises:
presenting the virtual preauthorized draft to the exchange network as an image.

3. The method of claim 1, wherein the presenting step comprises:
presenting the virtual preauthorized draft to the exchange network according to the Check Clearing for the 21^{st} Century Act procedure.

4. The method of claim 1, wherein the presenting step comprises:
printing the virtual preauthorized draft as a substitute check; and
presenting the substitute check to the exchange network.

5. The method of claim 1, wherein the creating step comprises inserting the customer information into an electronic form having the design of a draft.

6. The method of claim 1, wherein the exchange network includes a paying institution.

7. A system for processing a preauthorized draft, comprising:
a processor; and
a memory in communication with the processor, the memory storing a plurality of processing instructions for directing the processor to:
receive customer information including a routing number, transit number, account number, and amount of payment;
create a virtual preauthorized draft based on the customer information, wherein the format of the virtual preauthorized draft resembles standard check format; and
present the virtual preauthorized draft to an exchange network for payment on the draft.

8. The system of claim 7, wherein the instructions for directing the processor to present comprises instructions for directing the processor to present the virtual preauthorized draft to the exchange network as an image.

9. The system of claim 7, wherein the instructions for directing the processor to present comprises instructions for directing the processor to present the virtual preauthorized draft to the exchange network according to the Check Clearing for the 21^{st} Century Act procedure.

10. The system of claim 7, wherein the instructions for directing the processor to present comprise a plurality of instructions for directing the processor to print the virtual preauthorized draft as a substitute check.

11. The system of claim 7, wherein the instructions for directing the processor to create comprise instructions for directing the processor to insert the customer information into an electronic form having the design of a check.

12. The system of claim 7, wherein the exchange network includes a paying institution.

13. A computer program product comprising a computer usable medium having control logic stored therein for causing a computer to process a preauthorized draft, said control logic comprising:
first computer readable program code means for causing the computer to receive customer information including a routing number, transit number, account number, and amount of payment;
second computer readable program code means for causing the computer to create a virtual preauthorized draft based on the customer information, wherein the format of the virtual preauthorized draft resembles standard check format; and
third computer readable program code means for causing the computer to present the virtual preauthorized draft to an exchange network for payment on the draft.

14. The computer program product of claim 13, wherein the third computer readable program code means further causes the computer to present the virtual preauthorized draft to the exchange network as an image.

15. The computer program product of claim 13, wherein the third computer readable program code means further causes the computer to present the virtual preauthorized draft to the exchange network according to the Check Clearing for the 21^{st} Century Act procedure.

16. The computer program product of claim 13, wherein the third computer readable program code means comprises computer readable program code means for causing the computer to print the virtual preauthorized draft as a substitute check.

17. The computer program product of claim 13, wherein the second computer readable program code means comprises computer readable program code means for causing the computer to insert the customer information into an electronic form having the design of a check.

18. The computer program product of claim 13, wherein the exchange network includes a paying institution.
